(19) United States
(12) Patent Application Publication
(10) Pub. No.: US 2024/0412725 A1
(43) Pub. Date: Dec. 12, 2024

(54) PRESENTATION EVALUATION DEVICE

(71) Applicant: INTERACTIVE SOLUTIONS CORP., Tokyo (JP)

(72) Inventor: Kiyoshi SEKINE, Tokyo (JP)

(73) Assignee: INTERACTIVE SOLUTIONS CORP., Tokyo (JP)

(21) Appl. No.: 18/702,794

(22) PCT Filed: Apr. 10, 2023
(86) PCT No.: PCT/JP2023/014592

§ 371 Date: Apr. 18, 2024

(30) Foreign Application Priority Data
Apr. 12, 2022 (JP) 2022-065821

(51) Int. Cl. G10L 15/08

(52) U.S. Cl. CPC G10L 15/08

(57) ABSTRACT

[Problem] To provide a presentation evaluation device for evaluating a presentation using the proportion of spoken notes among explanatory notes. [Solution] A presentation evaluation device having a speech analysis unit 3 for analyzing speech, a presentation-material-related information storage unit 5, a sentence storage unit 19, and a presentation evaluation unit 9. The presentation evaluation unit 9 reads one or a plurality of sentences for each of one or a plurality of explanatory notes from the sentence storage unit 19, determines whether or not one or a plurality of sentences for each of the one or plurality of explanatory notes is included and whether or not one or a plurality of explanatory notes are spoken by using spoken terms acquired by the speech analysis unit 3, and evaluates an inputted presentation on the basis of information pertaining to spoken notes among explanatory notes in presentation material stored in the presentation-material-related information storage unit 5.

### TECHNICAL FIELD

The present invention relates to a presentation evaluation device.

### BACKGROUND ART

JP 2020-119112 A describes a device that evaluates conversations using evaluation scores in terms of keywords, related words, and prohibited terms stored in an evaluation score storage means (claim 3). Presentation includes several explanations that are considered to be provided in relation to each page. The device described in this literature can evaluate conversations but cannot evaluate whether which of such explanations has been uttered.

### CITATION LIST

### Patent Literature

Patent Literature 1: JP 2020-119112 A

### SUMMARY OF INVENTION

### Technical Problem

In the case of evaluating conversations based on a keyword or the like, there is a problem that, even though an explanation of a key sentence is omitted, for example, if the keyword related to an explanation other than the key sentence is uttered, the conversations may be highly evaluated.

### SOLUTION TO PROBLEM

The above-described problem can be solved by, regarding one or more explanations stored in relation to a presentation, for example, if a predetermined or higher proportion of sentences included in each explanation have been uttered, determining that the explanation has been uttered and evaluating the presentation according to the proportion of the uttered explanation(s).

A first invention relates to a presentation evaluation device 1.

The presentation evaluation device has a speech analysis unit 3, a presentation material-related information storage unit 5, a sentence storage unit 19, and a presentation evaluation unit 9.

The speech analysis unit 3 is an element for analyzing speech.

The presentation material-related information storage unit 5 is an element for storing information related to a presentation material. The information related to the presentation material includes information for identifying each page of the presentation material and one or more explanations stored in relation to each page.

The sentence storage unit 19 is an element for storing one or more sentences in relation to the one or more explanations. If there is a plurality of explanations on a certain page, the sentence(s) is stored in relation to each explanation.

The presentation evaluation unit 9 is an element for evaluating a presentation. The presentation evaluation unit 9 reads the one or more sentences of each of the one or more explanations from the sentence storage unit 19.

The presentation evaluation unit 9 uses speech terms acquired by the speech analysis unit 3 to determine whether the one or more sentences of each of the one or more explanations have been uttered and determine whether the one or more explanations have been uttered, and evaluate the input presentation based on information of provided explanation(s), among the explanations of the presentation material that are stored in the presentation material-related information storage unit 5.

A preferred example of the presentation evaluation device 1 further has an utterance- required explanation display unit 11. The utterance-required explanation display unit 11 is an element for displaying an utterance-required explanation on a display unit. The utterance- required explanation refers to an explanation determined as having not yet been uttered by the presentation evaluation unit 9, among the explanations of the presentation material stored in the presentation material-related information storage unit 5. The utterance-required explanation display unit 11 reads the utterance-required explanation from the presentation material-related information storage unit 5 and displays the same on the display unit.

A preferred example of the presentation evaluation device 1 further has an explanation status display unit 13.

The explanation status display unit 13 is an element for displaying, on the display unit, the information related to each page, information related to the one or more explanations, and information related to the explanation having been provided by the input presentation, among the one or more explanations.

A preferred example of the presentation evaluation device 1 further has a keyword storage unit 7 and a keyword adoption rate evaluation unit 15. The keyword storage unit 7 is an element for storing one or more keywords in relation to the one or more explanations. The keyword adoption rate evaluation unit 15 is an element for further evaluating the input presentation using information related to a keyword included in the speech terms, among the keyword(s) stored in relation to the presentation material.

A preferred example of the presentation evaluation device 1 further has a topic word extraction unit 17. The topic word extraction unit 17 is an element for using the speech terms acquired by the speech analysis unit 3 to extract topic words that are included in the speech terms and serve as an impetus for grasping the contents of the presentation. In this case, the presentation evaluation unit 9 preferably further evaluates the input presentation, using information related to a topic word among the topic words, which is stored in the keyword storage unit 7 and is equivalent to the one or more keywords stored in relation to the presentation.

A preferred example of the presentation evaluation device 1 stores, in the keyword storage unit 7, a topic word that is in common among highly evaluated presentations among the input presentations evaluated by the presentation evaluation unit 9 and is not registered as the one or more keywords in the keyword storage unit 7, as a new keyword.

The next invention relates to a program that causes a computer to function as any of the above-described presentation evaluation devices.

The further next invention relates to an information recording medium recording the above-described program.

### Advantageous Effects of Invention

According to the present invention, it is possible to check if all explanations in relation to a presentation have been provided and to evaluate the presentation by the result of checking.

### BRIEF DESCRIPTION OF DRAWINGS

FIG. 1 is a conceptual diagram of a presentation evaluation device.

FIG. 2 is a conceptual diagram illustrating an example of display by an explanation status display unit.

### DESCRIPTION OF EMBODIMENTS

Hereinafter, embodiments for carrying out the present invention will be described with reference to the drawings. The present invention is not limited to the following embodiments and includes modifications of the following embodiments that are made as appropriate within the bounds of being obvious to persons skilled in the art.

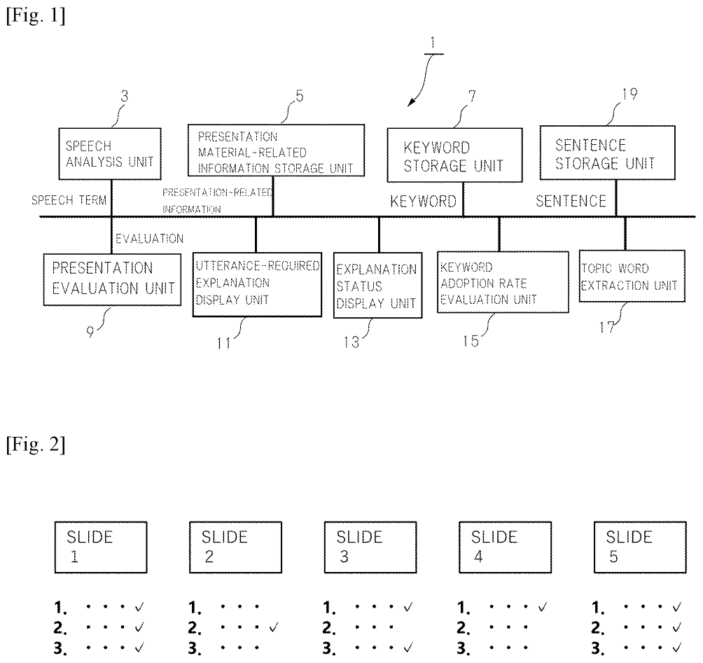

FIG. 1 is a conceptual diagram of a presentation evaluation device. As illustrated in FIG. 1, the device 1 has a speech analysis unit 3, a presentation material-related information storage unit 5, a sentence storage unit 19, and a presentation evaluation unit 9. The device 1 may further include any of elements, that is, an utterance-required explanation display unit 11, an explanation status display unit 13, a keyword adoption rate evaluation unit 15, and a topic word extraction unit 17. The presentation evaluation device 1 may further include a keyword storage unit 7, or may include the keyword storage unit 7 instead of the sentence storage unit 19. This system is a device implemented by a computer or a processor.

The computer has an input unit, an output unit, a control unit, an arithmetic operation unit, and a storage unit, and these elements are connected together by a bus or the like so as to be capable of exchanging information with one another. For example, the storage unit may store a control program or may store various kinds of information. If predetermined information is input from the input unit, the control unit reads the control program from the storage unit. Then, the control unit reads the information as appropriate from the storage unit and transfers the same to the arithmetic operation unit. The control unit also transfers input information as appropriate to the arithmetic operation unit. The arithmetic operation unit uses the received various kinds of information to perform arithmetic processing and stores the arithmetic processing results in the storage unit. The control unit reads the arithmetic processing results from the storage unit and outputs the same from the output unit. In this manner, various processes and steps are executed. The various processes are executed by the units and the means. The computer may have a processor, and the processor may implement the various functions and the various steps.

### Presentation Evaluation Device 1

The presentation evaluation device 1 is a device for evaluating presentations. The presentations include all matters that are uttered on the basis of materials, such as lectures, lessons, explanations, telephone correspondence, videophone calls, and conversations. The term presentation is used as a noun and also used like a verb.

### Speech Analysis Unit 3

The speech analysis unit 3 is an element for analyzing speech. Speech (presentation) input to the computer is converted into digital signals, for example, and then stored in the storage unit. The control unit of the computer reads the program from the storage unit to analyze the speech and stores the analyzed speech as speech terms in the storage unit.

### Presentation Material-Related Information Storage Unit 5

The presentation material-related information storage unit 5 is an element for storing information related to a presentation material. The storage unit of the computer functions as the presentation material-related information storage unit 5. The information related to the presentation material includes information for identifying each page of the presentation material and one or more explanations stored in relation to each page. The explanations refer to sentences that are expected to be uttered in the presentation or descriptions of the contents of the presentation, for example. In PowerPoint (registered trademark), for example, the explanations may be put into the Note field. Each explanation may be a keyword, may be one sentence, or may include a plurality of sentences.

### Keyword Storage Unit 7

The keyword storage unit 7 is an element for storing one or more keywords in relation to one or more explanations. The storage unit of the computer functions as the keyword storage unit 7. If there is a plurality of explanations on a certain page, the keyword storage unit 7 stores one or more keywords in relation to each explanation.

### Sentence Storage Unit 19

The sentence storage unit 19 is an element for storing one or more sentences in relation to one or more explanations. The storage unit of the computer functions as the sentence storage unit 19. If there is a plurality of explanations on a certain page, the sentence storage unit 19 may store one or more sentences in relation to each explanation.

### Presentation Evaluation Unit 9

The presentation evaluation unit 9 is an element for evaluating a presentation. For example, the input unit, control unit, arithmetic operation unit, and storage unit of the computer function as the presentation evaluation unit 9. A mode of the presentation evaluation unit 9 described herein evaluates a presentation using keywords, or adds up evaluation scores. The presentation evaluation unit 9 reads one or more keywords of each of the one or more explanations from the keyword storage unit 7.

The presentation evaluation unit 9 uses the speech terms acquired by the speech analysis unit 3 to determine whether the one or more keywords of each of the one or more explanations are included in the speech terms. Then, the presentation evaluation unit 9 determines whether the one or more explanations have been uttered, and evaluates the input presentation based on information of the uttered explanation(s), among the explanations of the presentation material that are stored in the presentation material-related information storage unit 5.

A method of evaluation by the presentation evaluation unit 9 may be any method. Thus, the presentation evaluation unit 9 may perform arithmetic processing as appropriate in response to a command from the program stored in the storage unit, based on the information of the uttered explanation(s), among the explanations of the presentation material stored in the presentation material-related information storage unit 5, and evaluate the input presentation.

For example, the case of evaluating a certain page alone will be described. This page includes four explanations A, B, C, and D, and A is a key sentence. For each of the explanations, a plurality of keywords such as A1, A2, A3, and A4 is stored in relation to the explanation. The computer compares the speech terms with the keywords. If A1, A2, A3,and A4 are all included in the speech terms, the computer determines that the explanation A has been provided. However, the computer may determine that the explanation A has been provided if a predetermined or higher proportion of keywords is included in the speech terms, such as if three of the four keywords are included. The storage unit of the computer may store a related word of each keyword, and if the related word is included in the speech terms, the computer may determine that the keyword related to the related word is included in the speech terms. In relation to the explanations A, B, C, and D, scores may be stored in the storage unit. The computer may read the scores related to the provided explanations and add up the read scores. In this manner, the computer may evaluate the presentation. If the presentation material includes a plurality of pages, the computer may add up the evaluation scores of these pages to evaluate the presentation through the entire presentation material. Coefficients may be different between important pages and unimportant pages. The above-described matter is an example. The presentation may be evaluated by adopting various arithmetic operation methods such that the presentation is more highly evaluated as more explanations are provided. The obtained evaluations and evaluation scores may be output as appropriate. For example, the obtained evaluations and evaluation scores may be displayed on the display unit of the computer.

### Presentation Evaluation Unit 9 Performing Evaluation on Whether Sentences have been Provided

The presentation evaluation unit 9 reads one or more sentences of each of the one or more explanations from the sentence storage unit 19.

The presentation evaluation unit 9 uses the speech terms acquired by the speech analysis unit 3 to determine whether the one or more sentences of the one or more explanations are included in the speech terms. For example, JP 2021-197015 A describes a neural machine translation model for inferring a target sentence from a source sentence. As such, there are publicly known sentence coincidence analysis devices that determine whether a sentence and another sentence coincide with each other. The presentation evaluation unit 9 of the present invention has a sentence coincidence analysis device, and uses the speech terms acquired by the speech analysis unit 3 to determine whether one or more sentences of each of the one or more explanations are included in the speech terms. Then, the presentation evaluation unit 9 determines whether the one or more explanations have been uttered, and evaluates the input presentation based on information of the provided explanation(s), among the explanations of the presentation material that are stored in the presentation material-related information storage unit 5. The method of evaluation by the presentation evaluation unit 9 may be any method. Thus, the presentation evaluation unit 9 may perform arithmetic processing as appropriate in response to a command from the program stored in the storage unit, based on the information of the provided explanation(s), among the explanations of the presentation material that are stored in the presentation material-related information storage unit 5. The specific evaluation example may be similar to the example using keywords described above. In this manner, the presentation evaluation unit 9 can obtain the evaluation value of the presentation based on sentences.

For example, the case of evaluating a certain page alone will be described. This page includes four explanations A, B, C, and D, and A is a key explanation. For each of the explanations, a plurality of sentences such as A1, A2, A3, and A4 is stored in relation to the explanation. The sentence is generally a sentence with a period “.” at the end. The computer compares the speech terms with the sentences. If the sentences A1, A2, A3, and A4 are all included in the speech terms, the computer determines that the explanation A has been provided. However, the computer may determine that the explanation A has been provided if a predetermined or higher proportion of sentences is included in the speech terms, such as if three of the four sentences are included. Moreover, the storage unit of the computer may store the keywords of each explanation. If predetermined or more (a predetermined or larger number of or a predetermined or higher proportion of) keywords related to either or both the explanation(s) and the sentence(s) that have been determined as not yet been provided are included in the speech terms, the storage unit of the computer may determine that the explanation(s) or the sentence(s) are included in the speech terms. In relation to the explanations A, B, C, and D, scores may be stored in the storage unit. The computer may read the scores related to the provided explanations, and add up the read scores. In this manner, the computer may evaluate the presentation. The method for calculating the evaluation scores may be any method. If the presentation material includes a plurality of pages, the computer may add up the evaluation scores of these pages to evaluate the presentation through the entire presentation material. Coefficients may be different between important pages and unimportant pages. The above-described matter is an example. The presentation may be evaluated by adopting various arithmetic operation methods such that the presentation is more highly evaluated as more explanations are provided. The obtained evaluations and evaluation scores may be output as appropriate. For example, the obtained evaluations and evaluation scores may be displayed on the display unit of the computer.

The presentation evaluation device 1 in the above-described mode has the speech analysis unit 3, the presentation material-related information storage unit 5, the sentence storage unit 19, and the presentation evaluation unit 9.

The sentence storage unit 19 is an element for storing one or more sentences related to one or more explanations. If there is a plurality of explanations on a certain page, the sentences are stored in relation to the corresponding explanations.

The presentation evaluation unit 9 is an element for evaluating a presentation. The presentation evaluation unit 9 reads the one or more sentences of each of the one or more explanations from the sentence storage unit 19.

The presentation evaluation unit 9 uses speech terms acquired by the speech analysis unit 3 to determine whether the one or more sentences of each of the one or more explanations are included in the speech terms, and determine whether the one or more explanations have been uttered, and evaluate the input presentation based on information of provided explanation(s), among the explanations of the presentation material that are stored in the presentation material-related information storage unit 5.

The presentation evaluation unit 9 may obtain the evaluation value of the presentation based on keywords and evaluate the presentation in accordance with the evaluation value of the presentation based on keywords. For example, the presentation evaluation unit 9 may output the evaluation value or may output a grade based on the evaluation value. The presentation evaluation unit 9 may obtain the final evaluation value using the evaluation value of the presentation based on keywords and the evaluation value of the presentation based on sentences. The method for obtaining the final evaluation value is publicly known, and the final evaluation value can be obtained using a publicly known arithmetic operation. The presentation evaluation unit 9 may read the evaluation value of the presentation based on keywords and the evaluation value of the presentation based on sentences from the storage unit, and cause the arithmetic operation unit to perform arithmetic processing based on the program read from the storage unit, thereby obtaining the final evaluation value. An example of the arithmetic operation is to sum up the evaluation value of the presentation and the evaluation value of the presentation based on sentences. Another example of the arithmetic operation is to multiply either or both of the evaluation value of the presentation and the evaluation value of the presentation based on sentences by an appropriate coefficient, and add up the resultants, thereby obtaining the final evaluation value. The mode in which the presentation evaluation unit 9 evaluates the presentation in accordance with the evaluation value of the presentation based on sentences is different from the mode described above herein.

The above-described presentation evaluation device is a device based on a computer. The computer stores information related to a presentation material. The information related to a presentation material includes information for identifying each page of the presentation material and one or more explanations stored in relation to each page.

Th computer stores one or more keywords in relation to the one or more explanations.

When a presentation is input into the computer, the computer analyzes speech of the presentation and acquires speech terms that are terms included in the input presentation.

The computer reads the one or more keywords of each of one or more explanations.

The computer uses speech terms to determine whether the one or more keywords of each of the one or more explanations are included in the speech terms and determine whether the one or more explanations have been uttered, and evaluate the input presentation based on information of provided explanation(s) among the explanations of the presentation material.

Another mode different from the above-described mode is as follows.

The computer reads one or more sentences of each of one or more explanations.

The computer uses speech terms to determine whether the one or more sentences of each of the one or more explanations are included in the speech terms, and determine whether the one or more explanations have been uttered, and evaluate the input presentation based on information of provided explanation(s), among the explanations of the presentation material.

### Utterance-Required Explanation Display Unit 11

The utterance-required explanation display unit 11 is an element for displaying an utterance-required explanation on the display unit. The utterance-required explanation is an explanation that is determined as having not been provided by the presentation evaluation unit 9, among the explanations of the presentation material stored in the presentation material- related information storage unit 5. The utterance-required explanation display unit 11 reads the utterance-required explanation from the presentation material-related information storage unit 5 and displays the same on the display unit.

For example, it is assumed that, in relation to the explanation B, keywords B1, B2, B3,and B4 are stored in the storage unit. The computer compares the speech terms with the keywords B1, B2, B3, and B4. For example, if the computer determines that any of the keywords B1, B2, B3, and B4 is not included in the speech terms, the computer determines that the explanation B has not been provided. At that time, for example, the explanation rate of the keywords may be stored, and if the actual performance falls below the explanation rate, the computer may determine that the explanation B has not been provided. For example, with the explanation rate of 70%, if any two or more of the keywords B1, B2, B3, and B4 are not included in the speech terms, the computer may determine that the explanation B has not been provided.

In this case, the explanation B may be displayed on the speaker's monitor to urge the speaker to provide the explanation B. In addition, at the time of the speaker's reflecting on his/her presentation, the speaker may be allowed to know that the explanation B has not been provided.

### Explanation Status Display Unit 13

The explanation status display unit 13 is an element for displaying, on the display unit, information related to each page, information related to one or more explanations, and information related to an explanation having been provided by an input presentation, among the one or more explanations. An example of the information related to each page is the display of a thumbnail of each page of the presentation. The display of a thumbnail is deformed and small-sized display of the presentation.

FIG. 2 is a conceptual diagram illustrating an example of display by the explanation status display unit. In the example of FIG. 2, the presentation material includes five pages. Each page has three explanations. The explanations that have been provided by a person's presentation are check-marked. It can be seen that 10 of 15 explanations have been provided by the person's presentation. Displaying the explanation status in this manner allows the speaker to easily grasp which of the explanations have been provided.

### Keyword Adoption Rate Evaluation Unit 15

The keyword adoption rate evaluation unit 15 is an element for further evaluating the input presentation, using information related to keywords included in the speech terms, among the keywords stored in relation to the presentation material.

For example, the case of evaluating a certain page alone will be described. This page includes four explanations A, B, C, and D, and for each of the explanations, four keywords such as A1, A2, A3, and A4 are stored in relation to the explanation. Thus, total 16 keywords are stored on this page. The computer reads the keywords and compares the same with the speech terms. In this manner, the computer grasps the keywords included in the speech terms and the keywords not included in the speech terms. For example, if ten keywords are included in the speech terms related to the input presentation, the computer can determine the keyword adoption rate by dividing the number of the keywords included by the number of the keywords stored in the storage unit in relation to the certain page. The keyword adoption rate may be performed through the entire presentation material. The keyword adoption rate may be determined by using an appropriate arithmetic operation such that the adoption rate becomes higher with a larger number of keywords included.

### Topic Word Extraction Unit 17

The topic word extraction unit 17 is an element for using the speech terms acquired by the speech analysis unit 3 to extract topic words that are included in the speech terms and serve as an impetus for grasping the contents of the presentation. In this case, the presentation evaluation unit 9 preferably further evaluates the input presentation, using information related to a topic word that is stored in the keyword storage unit 7 and equivalent to one or more keywords stored in relation to the presentation, among the topic words.

For example, the case of obtaining a topic word on a certain page will be described. This page includes four explanations A, B, C, and D, and for each of the explanations, four keywords A1, A2, A3, and A4 are stored in relation to the explanation. The computer subjects the speech terms to word class analysis, extracts a plurality of nouns, and stores the same in the storage unit. Then, the computer reads the stored nouns, and performs an arithmetic operation of collating the nouns with the keywords stored in relation to the page. Accordingly, there is some noun among the nouns stored in the storage unit that is not equivalent to any of the keywords. The computer stores the noun as a candidate for the topic word in the storage unit. The candidate for the topic word may be set as the topic word. Internet search may be conducted by using the candidate for the topic word and the keywords related to the presentation material, and if a predetermined threshold anomaly candidate for the topic word and keywords are used on the same website, this candidate for the topic word may be set as the topic word. The arithmetic operation for setting the candidate for the topic word as the topic word may be an arithmetic operation that is adjusted as appropriate. In this manner, the topic word extraction unit 17 extracts the topic word from the speech terms. The extracted topic word is stored in the storage unit as appropriate.

### Keyword Update Unit

A preferred example of the presentation evaluation device 1 stores, in the keyword storage unit 7, a topic word that is in common among highly evaluated presentations, among the input presentations evaluated by the presentation evaluation unit 9, and is not registered as one or more keywords in the keyword storage unit 7, as a new keyword.

For example, in relation to presentations made by a plurality of persons, evaluation values and topic words are stored in the storage unit. The computer stores a threshold and sets persons with evaluation values equal to or higher than the threshold as high-grade presenters (highly evaluated presenters). If a certain topic word is used at a rate equal to or higher than a predetermined threshold in relation to the presentations made by the plurality of highly evaluated presenters, the computer stores the topic word as a new keyword in the storage unit.

This specification also discloses a program for causing a computer to function as the above-described device, a program for implementing a method based on the above-described device, and an information recording medium that stores such a program readable for the computer. The information recording medium is preferably a non-transitory recording medium. Examples of the information recording medium include a CD, a CD-ROM, a DVD, a USB memory, a hard disk, and a disc on a server.

### Industrial Applicability

The present invention relates to a presentation assistance device and thus can be used in the information-related industry.

### Reference Signs List

1 Presentation evaluation device
3 Speech analysis unit
5 Presentation material-related information storage unit
7 Keyword storage unit
9 Presentation evaluation unit
11 Utterance-required explanation display unit
13 Explanation status display unit
15 Keyword adoption rate evaluation unit
17 Topic word extraction unit
19 Sentence storage unit

1. A presentation evaluation device comprising:
a speech analysis unit (3) configured to analyze speech;
a presentation material-related information storage unit (5) configured to store information related to a presentation material, the information related to the presentation material including information for identifying each page of the presentation material and one or more explanations stored in relation to each page;
a sentence storage unit (19) configured to store one or more sentences in relation to the one or more explanations; and
a presentation evaluation unit (9) configured to evaluate a presentation, wherein
the speech analysis unit (3) acquires a speech term that is a term included in an input presentation, wherein
the presentation evaluation unit (9):
reads the one or more sentences of each of the one or more explanations from the sentence storage unit (19); and
uses the speech term acquired by the speech analysis unit (3) to determine whether the one or more sentences of each of the one or more explanations are included in the speech term and determine whether the one or more explanations have been uttered, and evaluate the input presentation based on information of the uttered explanation, among the explanations of the presentation material that are stored in the presentation material-related information storage unit (5),
the presentation evaluation device further comprises:
a keyword storage unit (7) configured to store one or more keywords in relation to the one or more explanations; and
a topic word extraction unit (17) configured to use the speech term acquired by the speech analysis unit (3) to extract topic words that are included in the speech term and serve as an impetus for grasping contents of the presentation, and
the presentation evaluation unit (9):
further evaluates the input presentation, using information related to a topic word among the topic words, the topic word being stored in the keyword storage unit (7) and being equivalent to the one or more keywords stored in relation to the presentation; and
stores the topic word that is in common among highly evaluated presentations, among the input presentations evaluated by the presentation evaluation unit (9), and is not registered as the one or more keywords in the keyword storage unit (7), as a new keyword in the keyword storage unit (7).

2. The presentation evaluation device according to claim 1, further comprising an utterance-required explanation display unit (11) configured to read, from the presentation material-related information storage unit (5), an utterance-required explanation that is an explanation determined as having not yet been uttered by the presentation evaluation unit (9), among the explanations of the presentation material stored in the presentation material-related information storage unit (5), and display the utterance-required explanation on a display unit.

3. The presentation evaluation device according to claim 1, further comprising an explanation status display unit (13) configured to display, on a display unit, the information related to each of the pages, information related to the one or more explanations, and information related to the explanation having been provided by the input presentation, among the one or more explanations.

4. The presentation evaluation device according to claim 1, further comprising:
a keyword storage unit (7) configured to store one or more keywords in relation to the one or more explanations; and
a keyword adoption rate evaluation unit (15) configured to further evaluate the input presentation, using information related to the keyword included in the speech term, among the keywords stored in relation to the presentation material.

5. The presentation evaluation device according to claim 1, further comprising a keyword storage unit (7) configured to store one or more keywords in relation to the one or more explanations, wherein
the presentation evaluation unit (9):
reads the one or more keywords of each of the one or more explanations from the keyword storage unit (7);
uses the speech term acquired by the speech analysis unit (3) to determine whether the one or more keywords of each of the one or more explanations are included in the speech term, determines whether the one or more explanations have been uttered, and obtains an evaluation value of the presentation based on keywords and an evaluation value of the presentation based on sentences, based on information of the uttered explanation, among the explanations of the presentation material that are stored in the presentation material-related information storage unit (5);
reads one or more sentences of each of the one or more explanations from the sentence storage unit (19);
uses the speech term acquired by the speech analysis unit (3) to determine whether the one or more sentences of each of the one or more explanations are included in the speech term, determines whether the one or more explanations have been uttered, and obtains an evaluation value of the presentation based on sentences, based on information of the uttered explanation, among the explanations of the presentation material that are stored in the presentation material- related information storage unit (5);
obtain a final evaluation value using the evaluation value of the presentation based on keywords and the evaluation value of the presentation based on sentences; and
evaluates the input presentation using the final evaluation value.

6. A program for causing a computer to function as a presentation evaluation device, the presentation evaluation device including:
a speech analysis unit (3) configured to analyze speech;
a presentation material-related information storage unit (5) configured to store information related to a presentation material, the information related to the presentation material including information for identifying each page of the presentation material and one or more explanations stored in relation to each page;
a sentence storage unit (19) configured to store one or more sentences in relation to the one or more explanations; and
a presentation evaluation unit (9) configured to evaluate a presentation, wherein
the speech analysis unit (3) acquires a speech term that is a term included in an input presentation, wherein
the presentation evaluation unit (9):
reads the one or more sentences of each of the one or more explanations from the sentence storage unit (19); and
uses the speech term acquired by the speech analysis unit (3) to determine whether the one or more sentences of each of the one or more explanations are included in the speech term and determine whether the one or more explanations have been uttered, and evaluate the input presentation based on information of the uttered explanation, among the explanations of the presentation material that are stored in the presentation material-related information storage unit (5),
the presentation evaluation device 1 further includes:
a keyword storage unit (7) configured to store one or more keywords in relation to the one or more explanations; and
a topic word extraction unit (17) configured to use the speech term acquired by the speech analysis unit (3) to extract topic words that are included in the speech term and serve as an impetus for grasping contents of the presentation, and
the presentation evaluation unit (9):
further evaluates the input presentation, using information related to a topic word among the topic words, the topic word being stored in the keyword storage unit (7) and being equivalent to the one or more keywords stored in relation to the presentation; and
stores the topic word that is in common among highly evaluated presentations, among the input presentations evaluated by the presentation evaluation unit (9), and is not registered as the one or more keywords in the keyword storage unit (7), as a new keyword in the keyword storage unit (7).

7. An information recording medium recording the program according to claim 6.
